(19) United States
(12) Patent Application Publication
(10) Pub. No.: US 2010/0119675 A1
(43) Pub. Date: May 13, 2010

(54) DOUGHNUT MAKING METHOD USING SOYBEAN POWDER

(76) Inventors: Myeon CHOE, Choonchun-si (KR); Ha Jin HWANG, Seoul (KR); Sung Yeon JO, Choonchun-si (KR); Jae Cheon IM, Dongdoochun-si (KR); Sang Hee KIM, Gangneung-si (KR); Tae Woo KIM, Taebaek-si (KR)

Correspondence Address: IPLA P.A., 3550 WILSHIRE BLVD., 17TH FLOOR, LOS ANGELES, CA, 90010, US

(21) Appl. No.: 12/610,304

(22) Filed: Oct. 31, 2009

(30) Foreign Application Priority Data
Nov. 7, 2008 (KR) 10-2008-0110448

(51) Int. Cl. A21D 13/08; A23L 1/29; A23L 1/01; A23L 1/20; A21D 2/00

(52) U.S. Cl. 426/440

(57) ABSTRACT

A doughnut making method comprises: pulverizing beans to bean powder using an airflow crushing technique; mixing flour, baking powder and whole milk powder to the bean powder to form a first mixture; mixing the first mixture to a second mixture to form a third mixture, wherein the second mixture is formed of refined sugar, salt and margarine; sieving the third mixture to form a premix; admixing water and egg mix to the premix and pasting the admixture to a dough; and frying the dough in oil to form doughnuts.

### CROSS REFERENCE

This application claims foreign priority under Paris Convention and 35 U.S.C. §119 to Korean Patent Application No. 10-2008-0110448, filed Nov. 7, 2008 with the Korean Intellectual Property Office.

### BACKGROUND

The present invention relates to a method of making doughnuts, and more particularly to an innovative soybean doughnut making method.

Doughnuts are formed either by joining the ends of a long, skinny piece of dough into a ring or by using a doughnut cutter, which simultaneously cuts the outside and inside shape, leaving a doughnut-shaped piece of dough and a doughnut hole from dough removed from the center. This smaller piece of dough can be cooked or re-added to the batch to make more doughnuts. A disk-shaped doughnut can also be stretched and pinched into a torus until the center breaks to form a hole. Alternatively, a doughnut depositor can be used to place a circle of liquid dough directly into the fryer. Doughnuts can be made from a yeast-based dough for raised doughnuts or a special type of cake batter.

Beans or soybeans are known to consist of fat 20%, protein 40%, carbohydrates 35%, and other nutrients 5% including some vitamins. Further, soybeans have quality proteins and they are less allergic than proteins in milk, thus good protein source to kids and babies as well as adults. In general, beans contains about 20 to 50% of proteins which consist of about 84% of globulin (glycinin), 4% of albumin, 4% of proteose, 6% of nitrogen compound. This means more than 80% of soybean proteins are formed of globulin glycinin and albumin legmelin. Further included in soybeans are core amino acid, lysine which lacks in grains, and a bunch of tryptophan. Soybeans, however, has a minimal amount of metionine.

A demand on the market is to provide healthy doughnuts with added natural ingredients. Another demand is to use less flour in doughnut making and improve nutrients with improved taste.

### SUMMARY OF THE INVENTION

The present invention is contrived to overcome the conventional disadvantages. An object of the invention is to introduce a method of making healthy doughnuts using soybean powder while maintaining property and characteristics of doughnuts.

Another object of the invention is to improve taste of doughnuts with added soybean powder from natural soybeans.

In order to achieve these and other objects, a doughnut making method according to the present invention comprises the steps of: pulverizing beans to bean powder using an airflow crushing technique; mixing flour, baking powder and whole milk powder to the bean powder to form a first mixture; mixing the first mixture to a second mixture to form a third mixture, wherein the second mixture is formed of refined sugar, salt and margarine; sieving the third mixture to form a premix; admixing water and egg mix to the premix and pasting the admixture to a dough; and frying the dough in oil to form doughnuts.

In an embodiment, the beans may be pulverized to the bean powder of about 30 to 1,000 mesh using an airflow crushing technique at the temperature of between zero and 50 centigrade.

The doughnuts may be deoiled in a natural condition. The beans are preferably soybeans or natural unprocessed soybeans. The weight ratio in the first mixture is about 40 to 60 wt % of the bean powder, about 32 to 48 wt % of flour, about 1.4 to 2.6 wt % of baking power, and about 6 to 10 wt % of whole milk powder. Whereas, the weight ratio in the second mixture is about 71.5 to 87.5 wt % of the first mixture, about 3 to 11 wt % of salt, about 80 to 92 wt % of sugar, and about 3 to 11 wt % of margarine. The third mixture is sieved in about 30 to 50 mesh.

In a preferred version, the frying may be performed in olive oil at about 140 to 200 centigrade for about 30 to 120 seconds.

Although the present invention is briefly summarized, the full understanding of the invention can be obtained by the following drawings, detailed description, and appended claims.

### DETAILED DESCRIPTION OF THE INVENTION

A doughnut making method according to the present invention comprises a first step of pulverizing beans to bean powder using an airflow crushing technique; a second step of mixing flour, baking powder and whole milk powder to the bean powder to form a first mixture; a third step of mixing the first mixture to a second mixture to form a third mixture, wherein the second mixture is formed of refined sugar, salt and margarine; a fourth step of sieving the third mixture to form a premix; a fifth step of admixing water and egg mix to the premix and pasting the admixture to a dough; a sixth step of frying the dough in oil to form doughnuts; and a seventh step of deoiling the doughnuts in a natural condition.

In an embodiment, the beans may be pulverized to the bean powder of about 30 to 1,000 mesh using an airflow crushing technique at the temperature of between zero and 50 centigrade. The beans are preferably soybeans or natural unprocessed soybeans. In a preferred version, the weight ratio in the first mixture is about 40 to 60 wt % of the bean powder, about 32 to 48 wt % of flour, about 1.4 to 2.6 wt % of baking power, and about 6 to 10 wt % of whole milk powder. The weight ratio in the second mixture is about 71.5 to 87.5 wt % of the first mixture, about 3 to 11 wt % of salt, about 80 to 92 wt % of sugar, and about 3 to 11 wt % of margarine. The third mixture is sieved in about 30 to 50 mesh. Preferably, the frying may be performed in olive oil at about 140 to 200 centigrade for about 30 to 120 seconds. Preferably, the dough consists of 60 to 70 weight percent of the premix, about 25 to 35 weight percent of water, and about 2 to 5 weight percent of the egg mix. Each step of the doughnut making method will now be described in further details.

The first step is to pulverize beans to bean powder using an airflow crushing technique preferably at the temperature of between zero and 50 centigrade. In the first step, beans are crushed and pulverized to powder by an airflow crusher. The beans can be natural beans, natural soybeans, dried beans or dried soybeans. It is recommended that the pulverizing by the airflow crusher be implemented in about 30 to 1,000 mesh at the temperature of between freezing point and 50 centigrade so as to solve problems in shaping doughnuts.

The conventional friction-applied crushing method tends to end up losing valid particles and nutrition of source material and consequently distorted taste and color resulting from heat generated during the friction crushing. Further, the convention friction crushing shows relatively low crushing efficiency. In this invention, the airflow crushing technique has been adopted to minimizes loss of valid particles and nutrition elements included in beans or soybeans while minutely pulverizing soybeans and at the same time erupting water-soluble elements of the soybeans.

The airflow crushing technique employs a method by which particles frequently crash each other to get further pulverized by air flow formed between a fast rotating impeller and a being-crushed area to maximize inclusion of valid particles in the soybean powder during the soybeans crushing while preventing valid particles from being destroyed by the crushing heat. Meanwhile, since soybean protein changes its property and becomes deteriorated in characteristics at the temperature above 50 centigrade, the temperature during the airflow crushing should remain between freezing point and 50 centigrade.

The soybeans are crushed to 30 to 1,000 mesh because powder in less than 30 mesh shows difficulty being mixed with other types of powder and because power in more than 1,000 mesh leads to low efficiency in terms of time period consumed for the mixture.

The second step is to mix flour, baking powder and whole milk powder to the bean powder to form a first mixture. In this step, the beans are preferably soybeans or natural unprocessed soybeans, and the weight ratio in the first mixture is about 40 to 60 wt % of the bean powder, about 32 to 48 wt % of flour, about 1.4 to 2.6 wt % of baking power, and about 6 to 10 wt % of whole milk powder.

The soybean powder provides savory and simple taste to doughnuts and enables making of tasty doughnuts with valuable nutrition like vitamins, mineral and proteins. In the second step, the 40 to 60 weight percent of soybean powder accounts for the first mixture and this is because the weight percent range enables making of simply tasty and savory doughnuts.

The baking powder is added to the soybean powder mixture to increase the volume and lighten the texture of doughnut paste in a short period of time and its efficiency remains solid when the added baking powder accounts for about 1.4 to 2.6 weight percent of the soybean powder mixture.

The whole milk powder is obtained by drying whole milk and returns to liquid milk when added to water and serves to generate a simply tasty flavor to the doughnuts. The recommended amount of whole milk powder to add tasty flavor would be 6 to 10 weight percent in the soybean powder mixture.

Alternately, The second step may be followed by a substep of seiving the first mixture to about 30 to 50 mesh to prevent clustering of the first mixture.

The third step is to mixing the first mixture to a second mixture to form a third mixture, wherein the second mixture is formed of refined sugar, salt and margarine. The weight ratio in the second mixture is about 71.5 to 87.5 wt % of the first mixture, about 3 to 11 wt % of salt, about 80 to 92 wt % of sugar, and about 3 to 11 wt % of margarine.

The 71.5 to 87.5 wt % of the first mixture serves to maintain product quality of the doughnuts without losing the simply tasty flavor. The weight percent of refined salt and sugar also serves to improve taste of doughnuts when added within the predetermined range. Margarine serves to soften shape and taste of doughnuts.

The fourth step is to sieve the third mixture to form a premix in about 30 to 50 mesh. The third mixture from the third step would experience clustering and clogging because a variety of different powder types have been mixed. Such clustering and clogging would result in uneven distribution of the mixed powder, thus causing difficulty in pasting. In order to solve the clustering possibilities, the third powder mixture is sieved in about 30 to 50 mesh to evenly distribute the powder mixture.

The fifth step is to admix water and egg mix to the premix and pasting the admixture to a dough. The sieved powder mixture in the fourth step is pasted with water, preferably purified water, and egg mix to form a dough or a long paste. Preferably, it is recommended that the dough consists of 60 to 70 weight percent of the premix, about 25 to 35 weight percent of water, and about 2 to 5 weight percent of the egg mix.

The six step is to fry the dough in oil to form doughnuts. Preferably, the frying is performed in olive oil at about 140 to 200 centigrade for about 30 to 120 seconds.

The dough obtained in the six step is fried in oil between 140 and 200 centigrade because frying under 140 centigrade may lead to loss of taste or color and if fried at above 200 centigrade may result in uneven frying and frying speed for inside and outside of the doughnuts. The oil for the frying may be selected from a variety of oils. The preferred oil is grape seed oil or olive oil. The time period of frying may be determined within the rage of 30 to 120 seconds depending upon shape and size of doughnuts

The seventh step is to deoil the doughnuts in a natural condition. The deoiling is recommended for a period of 4 to 6 minutes in a natural condition.

### EXAMPLE 1

### Soybean Doughnut Making

Soybeans are pulverized to soybean powder in 600 mesh using an airflow crushing technique at the temperature between freezing point and 50 centigrade. The obtained soybean powder 1,000 grams is mixed with flour 800 grams, baking powder 40 grams, and whole milk powder 160 grams to obtain mixed soybean powder. On the other hand. refined salt 200 grams, white sugar 160 grams and margarine 200 grams are mixed with each other to obtain mixed sugar powder.

The mixed soybean powder and the mixed sugar powder are admixed at the weight ratio of 8 to 2 so as to obtain a soybean powder premix. The obtained soybean power premix is sieved in 40 mesh and evenly distributed. The sieved soybean powder premix 600 grams is mixed with purified water 300 ml and egg mix 50 grams to form a dough. The obtained dough is fried in grape seed oil for about 45 seconds and deoiled for about 5 minutes in natural condition to obtain doughnuts.

### Comparison 1

### Non-Soybean Doughnut Making

The cake powder 1,000 grams is mixed with flour 800 grams, baking powder 40 grams, and whole milk powder 160 grams to obtain mixed powder. On the other hand. refined salt 200 grams, white sugar 160 grams and margarine 200 grams are mixed with each other to obtain mixed sugar powder.

The mixed powder and the mixed sugar powder are admixed at the weight ratio of 8 to 2 so as to obtain a powder premix. The obtained power premix is sieved in 40 mesh and evenly distributed. The sieved soybean powder premix 600 grams is mixed with purified water 300 ml and egg mix 50 grams to form a dough. The obtained dough is fried in grape seed oil for about 45 seconds and deoiled for about 5 minutes in natural condition to obtain doughnuts.

### Comparison 2

### Non-Soybean Doughnut Making

Another type of cake power applies to doughnuts with other conditions same as Comparison 1.

### Test 1: Test of Doughnut Tastes

Twenty people are selected who had training to test doughnut tastes. Doughnuts in Comparison 1 are soybean free doughnuts being sold in the commerce. Fields of the test include Sweet, Smell, Color, Taste, and Preference. Each field is scored 1 to 7 (where “7” means very good or very strong, “4” means moderate, and “1” means very poor or very weak).

TABLE 1

| | Sweet | Smell | Color | Taste | Preference |
|---|---|---|---|---|---|
| Example 1 | 6.3 | 6.8 | 6.8 | 6.5 | 6.6 |
| Comparison 1 | 4.1 | 4.2 | 4.5 | 3.5 | 3.9 |
| Comparison 2 | 4.3 | 3.8 | 4.6 | 2.8 | 3.1 |

As shown in Table 1, Example 1 had seemingly outstanding scores in taste, smell and other fields resulting from soybean application to the doughnuts with an airflow crushing. This result comes from soybeans and application of airflow crushing of the soybeans to soybean powder. The soybean doughnuts are better rated due to simply savory soybean taste and smell being applied to the doughnuts.

The results under Comparisons 1 and 2 come from friction-applied crushing and heat generated thereby. Such friction-generated heat also leads to unwanted loss of nutrition and taste, thus being low scored compared to Example 1.

The test result shows the soybean doughnut making method disclosed in this invention enables soybean doughnuts made thereby to maintain characteristic properties of soybeans with improved tastes.

While the invention has been shown and described with reference to different embodiments thereof, it will be appreciated by those skills in the art that variations in form, detail, compositions and operation may be made without departing from the spirit and scope of the invention as defined by the accompanying claims.

What is claimed is:

1. A doughnut making method, comprising:
pulverizing beans to bean powder using an airflow crushing technique;
mixing flour, baking powder and whole milk powder to the bean powder to form a first mixture;
mixing the first mixture to a second mixture to form a third mixture, wherein the second mixture is formed of sugar, salt and margarine;
sieving the third mixture to form a premix;
admixing water and egg mix to the premix and pasting the admixture to a dough; and
frying the dough in oil to form doughnuts.

2. The method of claim 1, further comprising deoiling the doughnuts.

3. The method of claim 1, wherein the beans are soybeans.

4. The method of claim 1, wherein the beans are natural unprocessed soybeans.

5. The method of claim 1, wherein the weight ratio in the first mixture is about 40 to 60 wt % of the bean powder, about 32 to 48 wt % of flour, about 1.4 to 2.6 wt % of baking power, and about 6 to 10 wt % of whole milk powder.

6. The method of claim 1, wherein the weight ratio in the second mixture is about 71.5 to 87.5 wt % of the first mixture, about 3 to 11 wt % of salt, about 80 to 92 wt % of sugar, and about 3 to 11 wt % of margarine.

7. The method of claim 1, wherein the third mixture is sieved in about 30 to 50 mesh.

8. The method of claim 1, wherein the frying is performed in olive oil at about 140 to 200 centigrade.

9. The method of claim 1, wherein the frying is performed in olive oil at about 140 to 200 centigrade for about 30 to 120 seconds.

10. A doughnut making method, comprising:
pulverizing beans to bean powder of about 30 to 1,000 mesh using an airflow crushing technique at the temperature of between zero and 50 centigrade;
mixing flour, baking powder and whole milk powder to the bean powder to form a first mixture;
mixing the first mixture to a second mixture to form a third mixture, wherein the second mixture is formed of sugar, salt and margarine;
sieving the third mixture to form a premix;
admixing water and egg mix to the premix and pasting the admixture to a dough; and
frying the dough in oil to form doughnuts.

11. The method of claim 10, further comprising deoiling the doughnuts.

12. The method of claim 10, wherein the beans are soybeans.

13. The method of claim 10, wherein the beans are natural unprocessed soybeans.

14. The method of claim 10, wherein the weight ratio in the first mixture is about 40 to 60 wt % of the bean powder, about 32 to 48 wt % of flour, about 1.4 to 2.6 wt % of baking power, and about 6 to 10 wt % of whole milk powder.

15. The method of claim 10, wherein the weight ratio in the second mixture is about 71.5 to 87.5 wt % of the first mixture, about 3 to 11 wt % of salt, about 80 to 92 wt % of sugar, and about 3 to 11 wt % of margarine.

16. The method of claim 10, wherein the third mixture is sieved in about 30 to 50 mesh.

17. The method of claim 10, wherein the frying is performed in olive oil at about 140 to 200 centigrade.

18. The method of claim 10, wherein the frying is performed in olive oil at about 140 to 200 centigrade for about 30 to 120 seconds.

19. The method of claim 10, wherein the frying is performed in grape seed oil at about 140 to 200 centigrade for about 30 to 120 seconds.

20. The method of claim 10, the dough comprises about 60 to 70 wt % of the premix, about 25 to 35 wt % of water, and about 2 to 5 wt % of the egg mix.
